(19) United States
(12) Patent Application Publication
(10) Pub. No.: US 2016/0363044 A1
(43) Pub. Date: Dec. 15, 2016

(54) APPARATUS AND METHOD FOR OPERATING RECIRCULATION VALVE FOR TURBOCHARGED ENGINE

(71) Applicants: KIA MOTORS CORPORATION, Seoul (KR); HYUNDAI MOTOR COMPANY, Seoul (KR)

(72) Inventor: Jeong Kyu LIM, Suwon-si (KR)

(21) Appl. No.: 14/959,665

(22) Filed: Dec. 4, 2015

(30) Foreign Application Priority Data
Jun. 12, 2015 (KR) 10-2015-0083236

(51) Int. Cl. F02B 37/12; F02D 41/00; F02B 39/16; B60T 17/02; B60T 13/52

(52) U.S. Cl. CPC F02B 37/12; B60T 17/02; B60T 13/52; F02B 39/16; F02D 41/0007

(57) ABSTRACT

An apparatus for operating a recirculation valve for a turbocharged engine includes a bypass line connected between an intake line, which is connected to an inlet side of a compressor for a turbocharger, and an intake line which is connected to an outlet side of the compressor; and a recirculation valve openably and closably mounted in the bypass line. A vacuum pump for operating a brake is connected to the recirculation valve such that the recirculation valve is opened by negative pressure of the vacuum pump.

### CROSS-REFERENCE TO RELATED APPLICATION

This application claims under 35 U.S.C. §119(a) the benefit of priority to Korean Patent Application No. 10-2015-0083236 filed on Jun. 12, 2015, the entire content of which is incorporated herein by reference.

### TECHNICAL FIELD

The present disclosure relates to an apparatus and a method for operating a recirculation valve for a turbocharged engine. More particularly, the present disclosure relates to an apparatus and a method for operating a recirculation valve for a turbocharged engine, which are capable of easily opening and closing the recirculation valve by using negative pressure of a vacuum pump for operating a brake.

### BACKGROUND

A turbocharger system uses air supplied to an intake side of an engine at a pressure higher than atmospheric pressure to increase the amount of intake air, which is introduced into a combustion chamber, in the engine without changing the size of the engine, such that it is possible to improve an engine output.

Referring to FIG. 1, a turbocharger system according to a related art recovers kinetic energy of exhaust gas discharged from an engine 10 to supercharge intake air supplied to the engine 10, and includes a turbocharge turbine 12 which is mounted at an exhaust side of the engine 10. A compressor 14 is coaxially connected with the turbocharge turbine 12 and supercharges the intake air supplied to the engine 10.

Therefore, the turbocharge turbine 12 rotates by pressure of exhaust gas discharged from an exhaust manifold of the engine 10, and the compressor 14 is operated at the same time. The intake air is supercharged by the compressor 14 in which the intake air is pressurized and supplied to a combustion chamber of the engine 10, and a large amount of air is supplied into the combustion chamber of the engine due to the supercharging, thereby improving efficiency in drawing the intake air and improving the engine output.

When a driver applies tip-out while releasing an accelerator pedal after accelerating the engine 10 by pressing the accelerator pedal, the supply of air to the engine is instantaneously shut off as a throttle valve is closed.

Therefore, when the throttle valve is rapidly closed, the intake air in an intake manifold (at a front end of the throttle valve) rapidly increases pressure at an outlet of the compressor 14, consecutively applies impact to the compressor 14 via an intercooler while forming a pulsating wave, and generates surge noise. Therefore, it is necessary to remove the intake surge pressure.

As a method of removing the intake surge pressure, as illustrated in FIG. 1, an intake line between the front end of the throttle valve 16 and the outlet of the compressor 14 is connected to an intake line between an air cleaner 18 into which the intake air first flows and an inlet of the compressor 14 by a bypass line 20. A recirculation valve (RCV) 22, which is openable and closable, is mounted in the bypass line 20, thereby removing pressure of the intake air, which causes surge noise, by bypassing the intake air to a front end of the compressor 14. Here, an operation of opening and closing the recirculation valve 22 is carried out by engine negative pressure.

A structure and an operation for opening and closing the recirculation valve in the related art will be described below.

FIG. 2 is a schematic view illustrating a structure for opening and closing the recirculation valve in the related art, and FIG. 3 is a flowchart illustrating an operation flow for opening and closing the recirculation valve in the related art.

As illustrated in FIG. 2, a separate vacuum chamber 32 is formed in an intake manifold 30 in order to store engine negative pressure for opening and closing the recirculation valve 22, and a check valve 34 is mounted in the vacuum chamber 32 so as to prevent the negative pressure from leaking.

Therefore, intake air is bypassed to a front end of the compressor 14 by producing the engine negative pressure in the intake manifold, storing the produced engine negative pressure in the vacuum chamber 32 formed in the intake manifold 30, applying a control signal for operating the recirculation valve 22, and opening the recirculation valve 22 using the engine negative pressure stored in the vacuum chamber 32.

However, when the separate vacuum chamber is formed in the intake manifold, there exist following problems.

First, since the vacuum chamber is in a space separated from an intake manifold runner when designing a mold for integrally forming the vacuum chamber in the intake manifold, the number of shell structures in the entire intake manifold increases, thus increasing overall size of the engine.

Second, in a case of a turbocharged engine, since negative pressure is not formed in the intake manifold when a vehicle accelerates, a larger capacity of the vacuum chamber needs to be ensured so that the recirculation valve is operated normally when acceleration and deceleration are consecutively repeated. In this case, the size of the vacuum chamber inevitably increases, which causes a problem about a layout in an engine room, and an increase in costs and weight.

The above information disclosed in this Background section is only for enhancement of understanding the background of the invention, and therefore, it may contain information that does not form the prior art that is already known in this country to a person of ordinary skill in the art.

### SUMMARY OF THE DISCLOSURE

The present discourse has been made in an effort to solve the above-described problems associated with the prior art, and to provide an apparatus and a method for operating a recirculation valve for a turbocharged engine which are capable of improving a degree of freedom associated with an engine layout by omitting a vacuum chamber configured in an intake manifold and capable of reducing manufacturing costs and weight, by operating the recirculation valve using a vacuum pump, which provides negative pressure for operating a brake, instead of using the vacuum chamber.

According to an embodiment in the present disclosure, an apparatus for operating a recirculation valve for a turbocharged engine includes a bypass line connected between an intake line at an inlet side of a compressor for a turbocharger and an intake line at an outlet side of the compressor; and a recirculation valve which is openably and closably mounted in the bypass line. A vacuum pump for operating a brake is connected to the recirculation valve such that the recirculation valve is opened by negative pressure of the vacuum pump.

According to another embodiment in the present disclosure, a method of operating a recirculation valve for a turbocharged engine includes closing a throttle valve when a driver applies tip-out while releasing an accelerator pedal; applying a control signal for operating a recirculation valve mounted between an intake line at an inlet side of a compressor for a turbocharger and an intake line at an outlet side of the compressor; supplying negative pressure of a vacuum pump for operating a brake, which is continuously operated, to the recirculation valve; and opening the recirculation valve by using negative pressure of the vacuum pump so that intake air is bypassed to the intake line at the inlet side of the compressor.

The vacuum pump for operating the brake may continuously produce negative pressure by rotation of an intake camshaft of an engine after the engine is started.

The negative pressure of the vacuum pump for operating the brake may be supplied to the recirculation valve when the driver applies the tip-out while releasing the accelerator pedal, and supplied to a brake operating mechanism when the driver presses a brake pedal.

Through the aforementioned technical solutions, the present disclosure provides the effects below.

First, the recirculation valve may be operated by using the vacuum pump, which provides negative pressure for operating the brake, instead of using a vacuum chamber of an intake manifold. Thus, it is possible to easily bypass the intake air, which rapidly increases pressure at the outlet of the compressor, to the inlet of the compressor, thereby suppressing surge noise caused by intake surge pressure.

Second, it is possible to omit the vacuum chamber in the related art from the intake manifold, improve a degree of freedom associated with an engine layout by reducing an overall size of the engine, and reduce manufacturing costs and weight by omitting the vacuum pump from the intake manifold.

Other aspects and exemplary embodiments are discussed infra.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles, e.g., fuel derived from resources other than petroleum. As referred to herein, a hybrid vehicle is a vehicle that has two or more sources of power, for example, both gasoline-powered and electric-powered vehicles.

The above and other features of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic view illustrating a structure of an intake and exhaust system of an engine which includes a turbocharger system.

FIG. 2 is a schematic view illustrating a structure for opening and closing a recirculation valve in the related art.

FIG. 3 is a flowchart illustrating an operation flow for opening and closing the recirculation valve in the related art.

FIG. 4 is a schematic view illustrating a structure for opening and closing a recirculation valve according to the present disclosure.

FIG. 5 is a flowchart illustrating an operation flow for opening and closing the recirculation valve according to the present disclosure.

It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, reference will now be made in detail to various embodiments in the present disclosure, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

Hereinafter, an exemplary embodiment in the present disclosure will be described in detail with reference to the accompanying drawings.

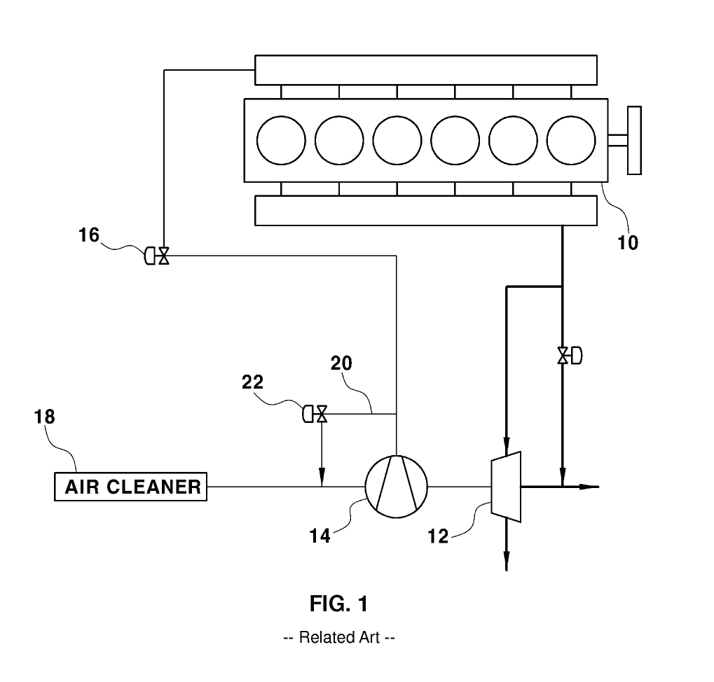

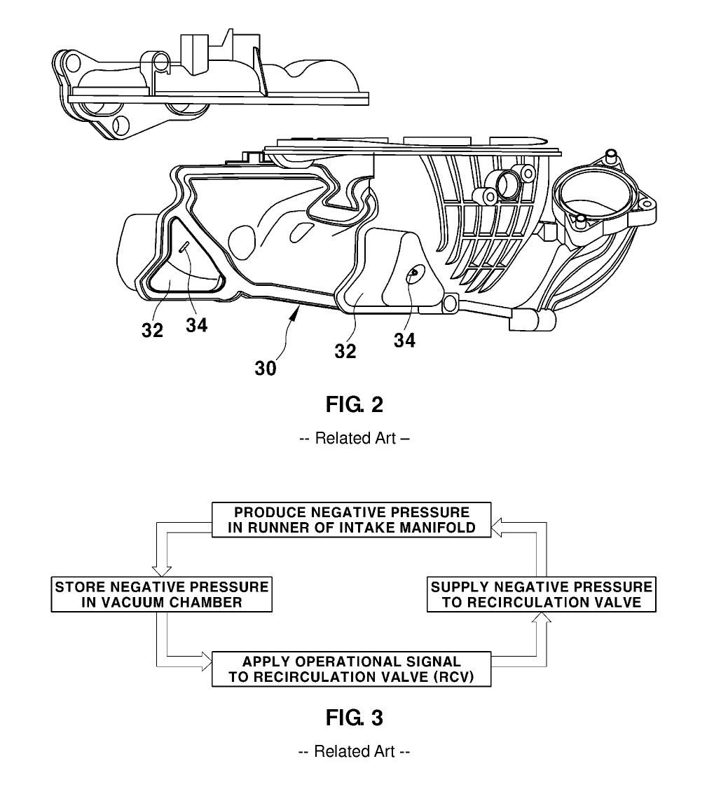

As described above with reference to FIG. 1, an intake line between a front end of a throttle valve 16 and an outlet of a compressor 14 is connected to an intake line between an air cleaner 18, into which intake air first flows, and an inlet of the compressor 14 by a bypass line 20. A recirculation valve (RCV) 22, which is openable and closable, is mounted in the bypass line 20, thereby removing pressure of the intake air, which causes surge noise, by bypassing the intake air to a front end of the compressor 14.

A structure and an operation for opening and closing a recirculation valve according to the present disclosure will be described below. Same numeral references will be used throughout the specification in reference with the structure of the related art.

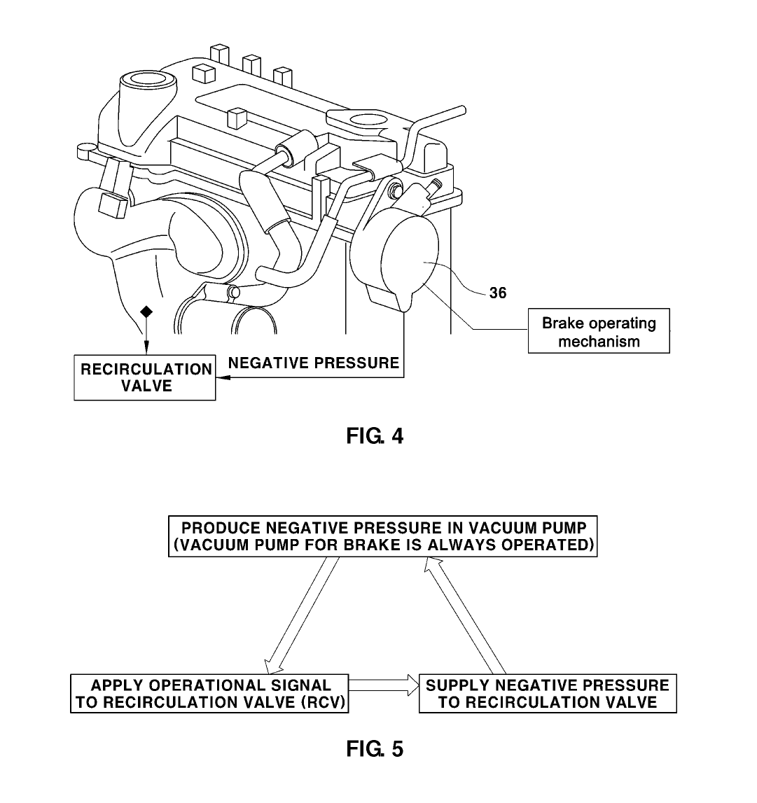

FIG. 4 is a schematic view illustrating a configuration for opening and closing a recirculation valve according to the present disclosure, and FIG. 5 is a flowchart illustrating an operation flow for opening and closing the recirculation valve according to the present disclosure.

When an intake line at an inlet side of a compressor 14 for a turbocharger and an intake line at an outlet side of a compressor are connected by a bypass line and a recirculation valve 22 is openably and closably mounted in the bypass line, a vacuum pump 36 for operating a brake is connected directly to the recirculation valve 22.

The vacuum pump 36 for operating the brake is attached at a side of an intake camshaft (not shown) of an engine 10, and always produces negative pressure while being operated by rotation of the intake camshaft after the engine 10 starts.

The negative pressure of the vacuum pump 36 for operating the brake may be used for different situations, that is, when a driver presses a brake pedal or when the driver releases an accelerator pedal.

That is, the negative pressure of the vacuum pump 36 for operating the brake is supplied to the recirculation valve 22 when the driver applies the tip-out while releasing the accelerator pedal, and supplied to a brake operating mechanism (e.g., a booster) when the user presses the brake pedal. Thus, the negative pressure of the vacuum pump 36 is not used for two or more components at the same time, thereby smoothly supplying the negative pressure to the recirculation valve 22 when the tip-out is applied.

The amount to which the driver releases the accelerator pedal when the driver applies the tip-out, that is, a differential value of a pedal opening degree, which is the amount of which the driver releases the accelerator pedal, may be considered. When the differential value of the pedal opening degree is equal to or greater than a predetermined value, the negative pressure may be supplied to the recirculation valve 22.

Therefore, when a throttle valve 16 is closed as the driver applies the tip-out, a control signal for operation is applied to the recirculation valve 22 which is mounted between the intake line at the inlet side of the compressor for a turbocharger and the intake line at the outlet side of the compressor, and the negative pressure of the vacuum pump 36 for operating the brake, which is always operated as described above, is supplied to the recirculation valve 22, such that the recirculation valve 22 is instantaneously opened by the negative pressure of the vacuum pump 36. The control signal is applied by, for example, an electronic control unit (ECU).

Therefore, a part of the intake air, which rapidly increases the pressure at the outlet of the compressor, is easily bypassed to the inlet of the compressor while passing through the recirculation valve 22 that is instantaneously opened. As a result, it is possible to prevent the pressure of the intake air from being rapidly increased at the outlet of the compressor, and suppress intake surge pressure and surge noise caused by the intake air supercharged by the compressor for a turbocharger.

As described above, the recirculation valve may be operated by using the vacuum pump, which provides negative pressure for operating the brake, instead of using a vacuum chamber configured in an intake manifold in the related art, thereby improving a degree of freedom associated with an engine layout by omitting the vacuum chamber and reducing manufacturing costs and weight by omitting a vacuum pump from the intake manifold.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for operating a recirculation valve for a turbocharged engine, the apparatus comprising:
a bypass line connected between an intake line, which is connected to an inlet side of a compressor for a turbocharger, and an intake line which is connected to an outlet side of the compressor; and
a recirculation valve openably and closably mounted in the bypass line,
wherein a vacuum pump for operating a brake is connected to the recirculation valve such that the recirculation valve is opened by negative pressure of the vacuum pump.

2. A method of operating a recirculation valve for a turbocharged engine, the method comprising:
closing a throttle valve when a driver applies tip-out while releasing an accelerator pedal;
applying a control signal by an Electronic Control Unit (ECU) for operating a recirculation valve which is mounted between an intake line at an inlet side of a compressor for a turbocharger and an intake line at an outlet side of the compressor;
supplying negative pressure of a vacuum pump for operating a brake, which is operated continuously, to the recirculation valve; and
opening the recirculation valve by using the negative pressure of the vacuum pump so that intake air is bypassed to the intake line at the inlet side of the compressor.

3. The method of claim 2, wherein the vacuum pump for operating the brake continuously produces the negative pressure by rotation of an intake camshaft of an engine after the engine starts.

4. The method of claim 2, wherein the negative pressure of the vacuum pump for operating the brake is supplied to the recirculation valve when the driver applies the tip-out while releasing the accelerator pedal and is supplied to a brake operating mechanism when the driver presses a brake pedal.

5. The method of claim 4, wherein, when the driver applies the tip-out, the negative pressure is supplied to the recirculation valve when a differential value of a pedal opening degree, which is the amount to which the driver releases the accelerator pedal, is equal to or greater than a predetermined value.

6. The method of claim 4, wherein the brake operating mechanism includes a booster.
